(19) United States
(12) Patent Application Publication
(10) Pub. No.: US 2019/0099943 A1
(43) Pub. Date: Apr. 4, 2019

(54) ADDITIVE MANUFACTURING METHOD AND APPARATUS

(71) Applicant: GENERAL ELECTRIC COMPANY, Schenectady, NY (US)

(72) Inventor: Stuart David Connell, Clifton Park, NY (US)

(21) Appl. No.: 15/724,088

(22) Filed: Oct. 3, 2017

(51) Int. Cl. B29C 64/153; B22F 3/105; B33Y 10/00; B33Y 30/00; B33Y 40/00; B29C 64/268; B29C 64/35

(52) U.S. Cl. CPC B29C 64/153; B22F 3/1055; B33Y 10/00; B33Y 30/00; B29K 2105/251; B29C 64/268; B29C 64/35; B22F 2003/1059; B33Y 40/00

(57) ABSTRACT

An additive manufacturing apparatus is presented. The additive manufacturing apparatus includes a housing defining a chamber, a build platform disposed in the chamber, a first gas inlet configured to supply a first gas flow above the build platform, a second gas inlet configured to supply a second gas flow above the first gas flow and in substantially same direction to the first gas flow and a gas outlet configured to discharge a gas flow. An additive manufacturing method for fabricating an article is also presented.

### BACKGROUND

The present disclosure relates generally to an additive manufacturing method and apparatus, and specifically, to an additive manufacturing method and apparatus that employ focused energy to selectively fuse a powder material to produce an object.

Additive manufacturing processes generally involve the buildup of one or more materials to make a net or near-net shape object, in contrast to subtractive manufacturing methods. Though “additive manufacturing” is an industry standard term (ASTM F2792), it encompasses various manufacturing and prototyping techniques known under a variety of names, including freeform fabrication, 3D printing, rapid prototyping/tooling, etc. A particular type of additive manufacturing process uses a focused energy for example, an electron beam or a laser beam, to sinter or melt a powder material, creating a solid three-dimensional object in which particles of the powder material are bonded together.

Laser sintering is a common industry term used to refer to producing three-dimensional (3D) objects by using a laser beam to sinter or melt a fine powder. In particular, laser sintering/melting techniques often entail projecting a laser beam onto a controlled amount of powder (for example, a powder bed) on a substrate, so as to form a layer of fused particles or molten material thereon. When the laser beam interacts with the powder at a powder bed, a particulate matter (for example, condensate, spatter) is produced within the chamber. This particulate matter may deposit onto the powder bed or other parts of the chamber such as laser window, which may be detrimental to the quality of the resulting object.

Generally, a gas flow is introduced in the chamber in an attempt to remove the particulate matter and prevent the deposition. However, the gas flow may entrain gas from the chamber resulting in a chaotic flow with large areas of recirculation within the chamber. This chaotic flow may provide a path for the particulate matter to various parts of the chamber including the laser window.

### BRIEF DESCRIPTION

Provided herein are improved additive manufacturing method and apparatus for fabricating an object. In one aspect, an additive manufacturing apparatus includes a housing defining a chamber, a build platform disposed in the chamber, a first gas inlet configured to supply a first gas flow above the build platform, a second gas inlet configured to supply a second gas flow above the first gas flow and in substantially same direction to the first gas flow, and a gas outlet configured to discharge a gas flow.

Another aspect is directed to an additive manufacturing method that includes (a) applying a focused energy to a quantity of a powder material provided on a build platform within a chamber to form a solidified layer, (b) supplying a first gas flow into the chamber above the build platform, and (c) supplying a second gas flow into the chamber above the first gas flow and in substantially same direction to the first gas flow.

### DRAWINGS

These and other features and aspects of embodiments of the invention will become better understood when the following detailed description is read with reference to the accompanying drawings in which like characters represent like parts throughout the drawings, wherein:

FIG. 1 shows a schematic representation of an additive manufacturing apparatus, in accordance with some embodiments of the present specification:

FIG. 2 is a schematic three-dimensional view illustrating a linear gas flow arrangement in the additive manufacturing apparatus of FIG. 1, in accordance with some embodiments of the present specification;

FIG. 3 is a schematic three-dimensional view illustrating a radial gas flow arrangement in the additive manufacturing apparatus of FIG. 1, in accordance with some embodiments of the present specification.

### DETAILED DESCRIPTION

The present disclosure generally encompasses apparatuses and methods for manufacturing objects using additive manufacturing. As discussed in detail below, some embodiments of the present disclosure present additive manufacturing apparatuses and methods that employ a first gas flow supplied above a build platform (i.e., above a powder bed disposed on the build platform) and a second gas flow supplied above the first gas flow and in substantially same direction to the first gas flow. This additional second gas flow advantageously overcome the above noted shortcomings by suppressing entrainment and recirculation of the first gas flow inside a chamber of the additive manufacturing apparatus and preventing deposition of a particulate matter on various locations inside the chamber including a laser window.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise. The terms “first”, “second”, and the like, as used herein do not denote any order, quantity, or importance, but rather are used to distinguish one element from another.

The present disclosure is described with respect particular embodiments and certain drawings, but the disclosure is not limited thereto and is only limited by the claims. The drawings described are only schematic and are non-limiting. In the drawings, the size of some of the elements or components may be exaggerated and not drawn to scale for illustrative purposes. The dimensions and relative dimensions do not correspond to actual dimensions to practice the disclosed apparatuses and methods.

The terms, as used herein, “additive manufacturing” and “additive manufacturing method” refer to methods for manufacturing objects using additive manufacturing technology, and these may be used interchangeably throughout the specification. The additive manufacturing technology forms net or near-net shape structures through sequentially and repeatedly depositing and joining material layers in which material particles are bonded together. In some embodiments, the material layers are fused (for example, sintered or melted) together using a focused energy such as a laser beam or an electron beam. As used herein “near-net shape” means that a component is formed very close to the final shape of the object, not requiring significant traditional mechanical finishing techniques such as machining or grinding following the additive manufacturing. As used herein “net shape” means that the component is formed with the final shape of the component, not requiring any traditional mechanical finishing techniques such as machining or grinding following the additive manufacturing. Additive manufacturing methods and systems include, for example, and without limitation, vat photopolymerization, powder bed fusion, binder jetting, material jetting, sheet lamination, material extrusion, directed energy deposition and hybrid systems.

As used herein, the term “particulate matter” refers to a condensate or spatter generated when a focused energy interacts with a powder material in a chamber of an additive manufacturing apparatus while fabricating an article using additive manufacturing. This particulate matter may deposit on various parts of the chamber for example, the powder bed, laser window and affects the quality of the resulting article.

The present disclosure generally relates to additive manufacturing apparatus and methods that employ focused energy to selectively fuse a powder material to produce a three-dimensional object. According to some embodiments, an additive manufacturing apparatus is employed to generate a focused energy for example, a laser beam and perform a sintering/melting method capable of producing the object by melting the particles within successive layers of a powder material to form a solid homogeneous mass. Suitable additive manufacturing techniques include, but are not limited to, Direct Metal Laser Melting, Direct Metal Laser Sintering, Direct Metal Laser Deposition, Laser Engineered Net Shaping, Selective Laser Sintering, Selective Laser Melting, Electron Beam Melting, Selective Heat Sintering, Selective Photocure, Selective Deposition Lamination, Smooth Curvatures Printing, Multi-jet Fusion, Multi-jet Modeling, Ultrasonic Additive Manufacturing, Digital Light Processing, Fused Filament Fabrication, Fused Deposition Modeling, Stereolithography, Hybrid Systems or combinations thereof. These methods and systems may employ, for example, and without limitation, all forms of electromagnetic radiation, heating, sintering, melting, curing, binding, consolidating, pressing, embedding, or combinations thereof.

Some embodiments relate to a laser sintering/melting technology where layers of a powder material are laid down and irradiated with a laser beam so that the particles of the powder material within each layer are sequentially sintered or melted to solidify the layer and form a solidified layer. Detailed description of laser sintering/melting technology may be found in U.S. Pat. Nos. 4,863,538, 5,017,753, and 5,076,869.

In some embodiments, an additive manufacturing apparatus includes a housing defining chamber, a build platform disposed in the chamber, a first gas inlet configured to supply a first gas flow above the build platform, a second gas inlet configured to supply a second gas flow above the first gas flow and in substantially same direction to the first gas flow, and a gas outlet configured to discharge a gas flow. The gas flow that is being discharged or ejected from the chamber through the gas outlet (i.e., discharged gas flow), includes the first gas flow, the second gas flow and the particulate matter. In some embodiments, the first gas flow and the second gas flow travel laminarly in the chamber. In some other embodiments, the first gas flow and the second gas flow travel radially in the chamber. Further, in some embodiments, the second gas flow includes a uniform gas flow.

The term “uniform gas flow”, as used herein, means that the flow velocity of a gas flow does not vary across a path of the gas flow.

As used herein, the term, “a first gas flow above the build platform” means that the first gas flow is supplied tangentially to a surface of the build platform. In some embodiments, the first gas flow tangentially flows to a powder bed disposed on the build platform. In some embodiments, the first gas flow flows at a distance at least 1 centimeter (cm) above the surface of the build platform. In some embodiments, the distance is in a range from about 2 cm to about 5 cm. The term. “a second gas flow above the first gas flow”, as used herein, means that the second gas flow is supplied proximate to the first gas flow above the first gas flow for example, at a distance at least 1 cm from the first gas flow.

As used herein, the term “substantially same direction” means that the second gas flow travels substantially parallel to the first gas flow (and above the first gas flow) in the chamber with a deviation from a direction of the first gas flow from about −30 degrees to about 30 degrees. In some embodiments, the second gas flow may deviate from about −10 degrees to about 10 degrees from the first gas flow direction. While flowing inside the chamber, some amounts of the first gas flow and the second gas flow may mix depending on their speed, a distance between the first gas flow and the second gas flow, and size of openings.

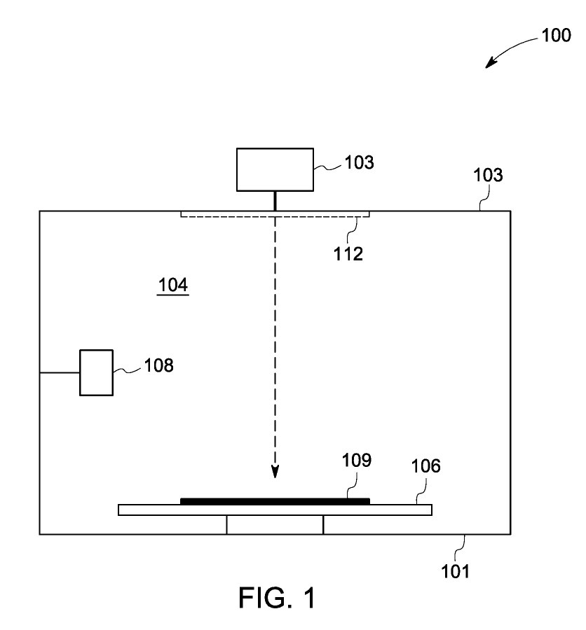

FIG. 1 schematically shows an additive manufacturing apparatus 100 for producing an article or object using a focused energy for example, laser beam, in some embodiments. The apparatus 100 includes a housing 102 defining a chamber 104 having a volume. The chamber 104 is sealable against the ambient atmosphere. A build platform 106 is disposed on a base portion 101 of the housing 102 inside the chamber 104, on which the article is fabricated. The apparatus 100 further includes a powder application device 108 which may be arranged in the chamber 104 to dispose a quantity of a powder material onto the build platform 106. The disposed powder material on the build platform 106 may form a powder bed 109. The build platform 106 may be movable in a vertical direction so that, with increasing construction height of the object while fabricating the object layer-by-layer, the build platform 106 can be moved downwards in the vertical direction.

The powder material may include, but is not limited to, polymers, plastics, metals, ceramics, sand, glass, waxes, fibers, biological matter, composites, or hybrids of these materials. These materials may be used in a variety of forms as appropriate for a given material and method, including for example without limitation, solids, powders, sheets, foils, tapes, filaments, pellets, wires, atomized, and combinations of these forms.

The apparatus 100 further includes an energy generating system for generating and directing a focused energy onto at least a portion of the build platform 106. As illustrated in FIG. 1, an energy generating system 110 is arranged on a top portion 103 of the housing 102, opposite to the base portion 101. The focused energy enters the chamber 104 through a window 112. The powder bed 109 disposed on the build platform 106 may be subjected to the focused energy in a selective manner as controlled by a controller (not shown in figures) depending on the desired geometry of the article.

In some embodiments, the energy generating system 110 includes a focused energy source for generating the focused energy. In some embodiments, the focused energy source includes a laser source for generating a laser beam, an electron beam source for generating an electron beam, or a combination thereof. In some embodiments, the laser source includes a pulsed laser source that generates pulsed laser beam. The pulsed laser beam is not emitted continuously, in contrast with a continuous laser radiation, but is emitted in a pulsed manner i.e., in time limited pulses with interval. In some embodiments, the energy generating system 110 includes a plurality of focused energy sources that is configured to selectively irradiate focused energies (e.g., laser beams) onto the powder bed 109. In embodiments where the focused energy includes a laser beam, the window 112 may be referred to as laser window.

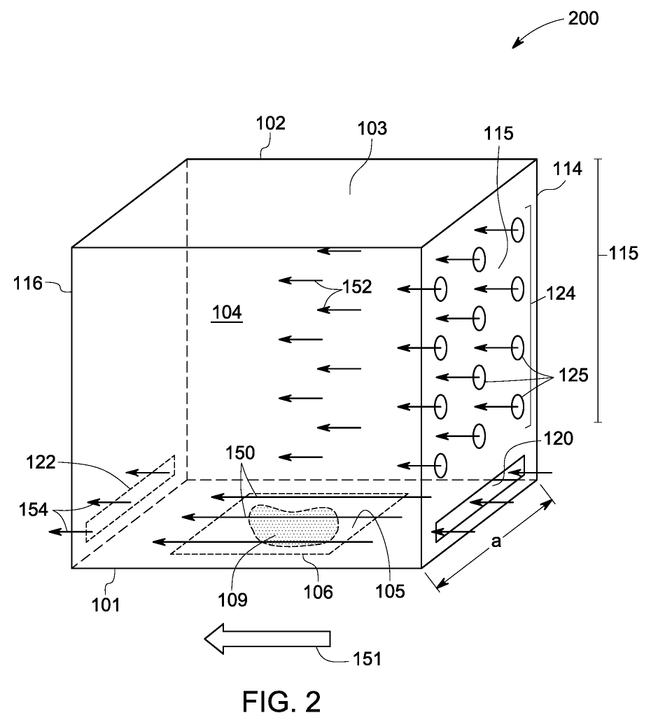

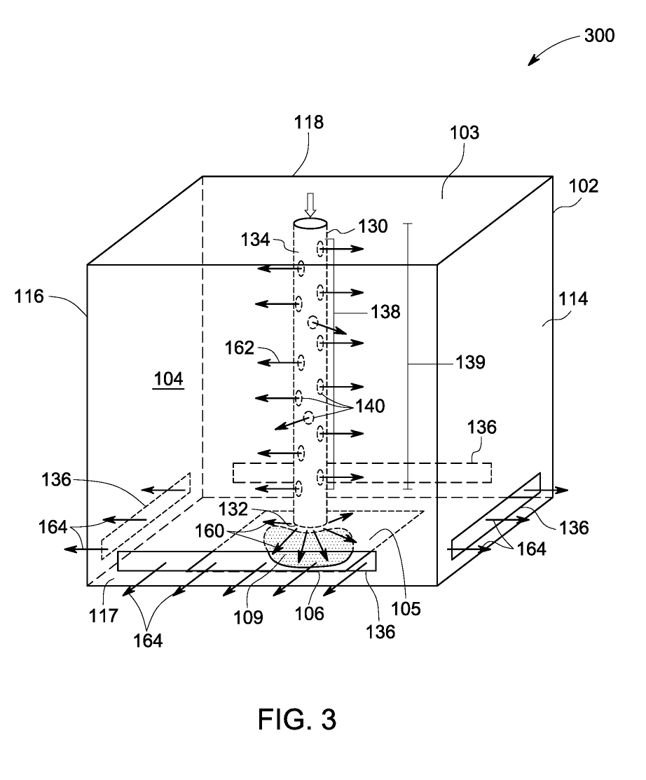

The additive manufacturing apparatus 100 is further configured to supply a first gas flow above the build platform 106 (or above the powder bed 109) in the chamber 104, a second gas flow above the first gas flow in the chamber 104, and discharge a gas flow from the chamber 104. The gas flow being discharged from the chamber includes the first gas flow, the second gas flow and the particulate matter that is generated on application of a focused energy to the powder bed 109 during forming a solidified layer for fabricating the desired article. The first gas flow and the second gas flow may be introduced or supplied either laminarly or radially in the chamber 104. FIGS. 2 and 3 illustrate different embodiments of the additive manufacturing apparatus 100 (FIG. 1). FIG. 2, in some embodiments, shows an additive manufacturing apparatus 200 having a laminar gas flow arrangement. FIG. 3, in some embodiments, shows an additive manufacturing apparatus 300 having a radial gas flow arrangement.

As illustrated in FIG. 2, the additive manufacturing apparatus 200 includes a first gas inlet 120 for supplying a first gas flow (shown by arrows 150) to the chamber 104 and a gas outlet 122 for discharging a gas flow (as shown by arrows 154) from the chamber 104. The first gas inlet 120 and the gas outlet 122 are configured to allow the first gas flow 150 to flow laminarly in a direction 151 above the build platform 106. As illustrated, the first gas inlet 120 is arranged at a first side-wall 114 and the gas outlet 122 is arranged at a second side-wall 116 opposing the first side-wall 114 of the housing 102. Further, the first gas inlet 120 and the gas outlet 122 are arranged on the respective side-walls (114, 116) at locations (for example, towards the base portion 101) such that the first gas flow 150 travels laminarly above an entire surface area of the build platform 106. As illustrated, the first gas inlet 120 extends along a width ‘a’ of the first side-wall 114 in a portion parallelly aligned to a side (facing the first side-wall 114) of the build platform 106. Similarly, the gas outlet 122 extends along a width ‘b’ of the second side-wall 116 in a portion parallelly aligned to another side (facing the second side-wall 116) of the build platform 106. Moreover, the first gas inlet 120 and the gas outlet 122 may be arranged towards the base portion 101 of the side-walls 114 and 116 such that the first gas flow 150 travels tangentially above the build platform 106.

The first gas inlet 120 and gas outlet 122 are shown rectangular in shape in FIG. 2 for simplicity. However, the first gas inlet 120 and gas outlet 122 can be of any shape for example, polygon or oval that enables to provide the first gas flow 150 above the entire surface area of the build platform 106. Further, the first gas inlet 120 may be connected to a gas dispersal mechanism that is connected to a gas supply line. The gas dispersal mechanism helps to uniformly supply the first gas flow 150 through the entire length of the first gas inlet 120. The gas outlet 122 may be connected to a suction mechanism to discharge the gas flow 154 from the chamber 104.

The additive manufacturing apparatus 200, as shown in FIG. 2, further includes a second gas inlet 124 for supplying a second gas flow to the chamber 104. The second gas inlet 124 is configured to supply the second gas flow (shown by arrows 152) above the first gas flow 150 and in substantially same direction (i.e., in the direction 151) to the first gas flow 150. As illustrated, the second gas inlet 124 is arranged at the first side-wall 114 above the first gas inlet 120. For example, the second gas inlet 124 may be arranged at least 1 centimeter above the first gas inlet 120. Further, in some embodiments, the second gas inlet 124 is arranged such that the second gas flow is uniformly distributed above the first gas flow throughout the chamber 104. As illustrated in FIG. 2, the second gas inlet 124 includes a plurality of openings 125 in the first side-wall 114 throughout a portion 115 of the first side-wall 114 extending above the first gas inlet 120 up to the top portion 103 of the housing 102. The plurality of openings 125 may include an array of openings that allows the second gas flow 152 to flow uniformly (i.e., uniform second gas flow) above the first gas flow 150. The openings may be of any shape and size that allow uniform gas flow. In some embodiments, the plurality of openings 125 may be in form of holes. In some embodiments, the holes may have a diameter in a range from about 1 mm to about 10 mm.

FIG. 3 illustrates the additive manufacturing apparatus 300 having a radial flow arrangement of a first gas flow and a second gas flow. In the additive manufacturing apparatus 300, a first gas inlet 132 is arranged above the build platform 106. In some instances, the first gas inlet 132 is arranged above a central portion of the build platform 106. The first gas inlet 132 is arranged such as to allow a first gas flow (shown by arrows 160) to flow radially (in a radial direction) in the chamber 104. Further, the first gas flow 160 in the chamber 104 travels tangentially above the build platform 106. The tangential flow may be maintained by controlling the flow speed and the distance between the build platform 106 and the first gas inlet 132. In some embodiments, the first gas inlet 132 is at least 1 cm above the build platform 106. The first gas inlet 132 may be a nozzle, which is connected to a conduit 130 disposed in the chamber 104. The conduit 130 may be connected to a gas supply line. The conduit 130 may be disposed substantially perpendicular to the build platform 106. The term, ‘substantially perpendicular’, as used herein, means that an angle between the conduit 130 and the surface 105 of the build platform 106 may range from 100 degrees to 80 degrees. Further, the additive manufacturing apparatus 300 includes at least one gas outlet 136 on a first side-wall 114 of the chamber 104 that allows the gas flow (shown by an arrow 164) including the first gas flow and the particulate matter to discharge from the chamber 104. In some embodiments, as illustrated in FIG. 3, each side-wall (114, 116, 117, 118) of the chamber 104 may include a gas outlet 136. The gas outlet 136 is similar to the gas outlet 122 as shown in FIG. 2 and described above with respect to FIG. 2. The gas outlet(s) 136 may be arranged towards the base portion 101 of the side-wall(s) such that the first gas flow 160 travels tangentially above the build platform 106. In this arrangement, the first gas inlet 132 and the gas outlet(s) 136 allow the first gas flow 160 to radially flow above the build platform 106 and the powder bed 109 and exit from the gas outlet(s) 136 of the side-wall(s) (114, 116, 117, 118). Each gas outlet 136 may be connected to a suction mechanism to discharge the gas flow from the chamber 104.

The additive manufacturing apparatus 300, as shown in FIG. 3, further includes a second gas inlet 138 for supplying a second gas flow (shown by arrows 162) in the chamber 104. The second gas inlet 138 is configured to supply the second gas flow 162 above the first gas flow 160 and in substantially same direction (i.e., radially) to the first gas flow 160. As illustrated, the second gas inlet 138 is arranged above the first gas inlet 132. The second gas inlet 138 may be arranged at a distance at least 1 cm from the first gas inlet 132. In some embodiments, the second gas inlet 138 is arranged such that the second gas flow 162 uniformly flows in the radial direction above the first gas flow 160 throughout the chamber 104. In some embodiments, as illustrated in FIG. 3, the second gas inlet 138 includes a plurality of openings 140 in a wall 134 of the conduit 130. The wall 134 includes the plurality of openings 140 arranged throughout a portion 139 of the wall 134, extending above the first gas inlet 132 up to the top portion 103 of the housing 102. The plurality of openings 140 may be arranged such as to allow the second gas flow 162 to flow uniformly above the first gas flow 162. The plurality of openings 140 may be of any shape and size that allows a uniform gas flow. In some embodiments, the plurality of openings 140 may be in form of holes. In some embodiments, the holes may have a diameter in a range from about 1 mm to about 10 mm.

The first gas flow (150, 160), the second gas flow (152, 162), or both supplied to the chamber 104 in embodiments shown in FIGS. 2 and 3 may include an inert gas such as, for example, argon, nitrogen or the like. It is however also conceivable to supply air to the chamber 104. The first gas flow (150, 160), the second gas flow (152, 162) or both may be supplied to the chamber 104 by a suitable conveying device such as, for example, a pump or a blower (not shown in the figures) via the first gas inlets (120, 132) and the second gas inlets (124, 138), respectively. In addition, one or more of the first gas inlets (120, 132), the second gas inlets (124, 138), and the gas outlets (122, 136) in FIGS. 2 and 3 may be connected to one or more controllers to control the first gas flow and the second gas flow in the chamber 104. The one or more controllers may control the speed and direction of the first gas flow and the second gas flow in the chamber 104.

Some embodiments of the present disclosure are directed to an additive manufacturing method for fabricating an article. The method includes (a) applying a focused energy to a quantity of a powder material provided on a build platform within a chamber to form a solidified layer, (b) supplying a first gas flow into the chamber above a surface of the build platform, and (c) supplying a second gas flow into the chamber above the first gas flow and in substantially same direction to the first gas flow. The steps (b) and (c) of the method may be performed simultaneously.

Referring to FIG. 2 and FIG. 3, the method includes the step (a) of providing a quantity of powder material on the build platform 106, which forms the powder bed 109. The step (a) further includes applying a focused energy from the energy generating system 110 to the powder bed 109. The focused energy melts the powder material of the powder bed 109 in a predefined manner to form a solidified layer. After forming the solidified layer, the method includes the step (b) of supplying a first gas flow into the chamber 104 above the build platform 106 i.e., above the solidified layer.

As used herein, the term “predefined manner” refers to a layout of a structure or geometry in which a plurality of solidified layers should be arranged to form the desired article.

Referring to FIG. 2, after performing the step (a), the method includes the step (b) of supplying the first gas flow 150 from the first gas inlet 120 in a direction 151. The first gas flow 150, in these embodiments, is laminar gas flow travelling above the build platform 106. The method further includes the step (c) of supplying the second gas flow 152 into the chamber 104 above the first gas flow 150 and in substantially same direction (i.e., 151) to the first gas flow 150. In some instances, the step (c) includes supplying the second gas flow 152 through the second gas inlet 124. Referring to FIG. 2, the step (c) includes supplying the second gas flow 152 through the plurality of openings 125. The method further includes discharging a gas flow including the first gas flow 150, the second gas flow 152 and the particulate matter from the chamber 104 through the gas outlet 122.

In some embodiments, referring to FIG. 3, the step (b) includes supplying the first gas flow 160 radially from the first gas inlet 132. The method further includes the step (c) of supplying the second gas flow 162 into the chamber 104 through the second gas inlet 138. That is, in these embodiments, the first gas flow 160 and the second gas flow 162 travel radially above the build platform 106 in the chamber 104. In some embodiments, as illustrated in FIG. 3, the step (c) includes supplying the second gas flow through the plurality of openings 140. The method further includes discharging a gas flow including the first gas flow 160, the second gas flow 162 and the particulate matter from the chamber 104 through the gas outlet(s) 136.

Referring to FIGS. 2 and 3, in some embodiments, the step (c) of supplying the second gas flow (152, 162) includes supplying a uniform gas flow (discussed previously). The uniform second gas flow in the chamber 104 above the first gas flow may help in streamlining the total gas flow in the chamber 104 by suppressing recirculation of the first gas flow. The plurality of openings 125 (FIG. 2) or 140 (FIG. 3) enables to uniformly distribute the second gas flow (152, 162) in the chamber 104 above the first gas flow (150, 160). Moreover, in some embodiments, the second gas flow (152, 162) has a mass flow substantially equal to a mass flow of the first gas flow (150, 160). In some embodiments, the mass flow of the second gas flow (152, 162) may be in a range 0.5 time the mass flow of the first gas flow (150, 160) to 5.0 times the mass flow of the first gas flow (150, 160). In some embodiments, the mass flow of the second gas flow (152,162) is equal to the mass flow of the first gas flow (150, 160).

In some embodiments, the step (b) and the step (c) may be performed simultaneously. That is, the method includes simultaneously supplying the first gas flow (150, 160) and the second gas flow (152, 162) in the chamber 104. When the first gas flow (150, 160) and the second gas flow (152, 162) travel in the chamber 104 above the build platform 106, these first and second gas flows entrain the particulate matter that was generated during performing the step (a). The gas flow (154, 164) including the first gas flow (150, 160), the second gas flow (152, 162) and the particulate matter, exits from the chamber 104 through the gas outlet 122 (FIG. 2) or the gas outlets 136 (FIG. 3). After performing the steps (b) and (c), the method includes repeating the step (a) for forming at least one additional solidified layer on the previously formed solidified layer. In some embodiments, the method further includes performing the steps (b) and (c) every time after performing the step (a). In some embodiments, the method includes repeating the steps (a), (b) and (c) multiple times for forming successive additional solidified layers to form the desired article. The steps (b) and (c) help in removing a particulate matter generated during the step (a).

As discussed previously, a linear or radial gas flow is typically supplied to the chamber to remove/entrain the particulate matter. However, when such a gas flow is supplied, it may recirculate inside the chamber and form a chaotic flow in the chamber. This chaotic flow provides a path for the particulate matter to deposit on various parts of the chamber, which may lower the quality of the resulting object. A second gas flow supplied to the chamber, as discussed above in some embodiments, suppresses the entrainment and recirculation of the first gas flow, and enables to streamline the total gas flow travelling above the build platform in the chamber.

While only certain features of the disclosure have been illustrated and described herein, many modifications and changes will occur to those skilled in the art. It is, therefore, to be understood that the appended claims are intended to cover all such modifications and changes as fall within the scope of the disclosure.

1. An additive manufacturing apparatus, comprising:
a housing defining a chamber;
a build platform disposed in the chamber;
a first gas inlet configured to supply a first gas flow above the build platform;
a second gas inlet configured to supply a second gas flow above the first gas flow and in substantially same direction to the first gas flow; and
a gas outlet configured to discharge a gas flow from the chamber.

2. The additive manufacturing apparatus of claim 1, wherein the first gas inlet is arranged at a first side-wall and the gas outlet is arranged at a second side-wall opposing the first side-wall of the housing.

3. The additive manufacturing apparatus of claim 2, wherein the second gas inlet is arranged at the first side-wall.

4. The additive manufacturing apparatus of claim 3, wherein the second gas inlet is arranged above the first gas inlet.

5. The additive manufacturing apparatus of claim 4, wherein the second gas inlet is arranged at least 1 centimeter above the first gas inlet.

6. The additive manufacturing apparatus of claim 3, wherein the second gas inlet comprises a plurality of openings in the first side-wall.

7. The additive manufacturing apparatus of claim 1, wherein the first gas inlet is disposed above the build platform.

8. The additive manufacturing apparatus of claim 7, wherein the first gas inlet comprises a nozzle of a conduit disposed above the build platform in the chamber.

9. The additive manufacturing apparatus of claim 8, wherein the second gas inlet is arranged above the first gas inlet.

10. The additive manufacturing apparatus of claim 9, wherein the second gas inlet is disposed at least 1 centimeter above the first gas inlet.

11. The additive manufacturing apparatus of claim 9, wherein the second gas inlet comprises a plurality of openings in a wall of the conduit disposed above the build platform in the chamber.

12. The additive manufacturing apparatus of claim 7, wherein the gas outlet is arranged at least in a first side-wall of the housing.

13. An additive manufacturing method for fabricating an article, comprising:
(a) applying a focused energy to a quantity of a powder material provided on a build platform within a chamber to form a solidified layer;
(b) supplying a first gas flow into the chamber above the build platform; and
(c) supplying a second gas flow into the chamber above the first gas flow and in substantially same direction to the first gas flow.

14. The additive manufacturing method of claim 13, wherein the first gas flow is supplied laminarly above the build platform.

15. The additive manufacturing method of claim 13, wherein the first gas flow is supplied radially above the build platform.

16. The additive manufacturing method of claim 13, wherein the second gas flow has a mass flow substantially equal to a mass flow of the first gas flow.

17. The additive manufacturing method of claim 13, wherein the step (c) comprises supplying the second gas flow uniformly in the chamber.

18. The additive manufacturing method of claim 13, further comprising repeating the step (a) for forming at least one additional solidified layer on said solidified layer after performing the steps (b) and (c).
